(19) United States
(12) Patent Application Publication
(10) Pub. No.: US 2016/0275002 A1
(43) Pub. Date: Sep. 22, 2016

(54) IMAGE CAPTURE IN APPLICATION LIFECYCLE MANAGEMENT FOR DOCUMENTATION AND SUPPORT

(71) Applicant: Laura RADCLIFF, Fort Collins, CO (US)

(72) Inventor: Laura RADCLIFF, Fort Collins, CO (US)

(73) Assignee: CA, Inc., New York, NY (US)

(21) Appl. No.: 14/661,431

(22) Filed: Mar. 18, 2015

(51) Int. Cl. G06F 11/36; G06F 17/30; G06F 9/44; H04L 12/26

(52) U.S. Cl. CPC G06F 11/3672; H04L 43/50; G06F 17/30424; G06F 8/71

(57) ABSTRACT

Systems and methods may include performing a series of test processes in relation to an application. The systems and methods may include recording a datastream while performing the test processes. The datastream may include image data representing images of the application, which may each correspond to a state of the application. The systems and methods may include creating entries in a database that may include information identifying each test process and the images. The systems and methods may include determining that the test processes have been completed. The systems and methods may include querying the database for the information identifying each test process and the images. The systems and methods may include organizing the information identifying each test process and the images into a structured format. The systems and methods may include generating a documentation file presenting the information identifying each test process and the images in the structured format.

### BACKGROUND

The present disclosure relates to product development and, more specifically, to systems and methods for image capture in application lifecycle management for documentation and support.

Existing development environments may permit developers to perform various tests in order to debug application code during the development process. After such developers have finished testing a particular version of the code, such developers may revise the application code to correct (problems and/or to improve the application, thereby generating a new version of the application code that also may be debugged using various tests.

After developers have finished testing a particular version of the application code, a documentation team may apply a series of known tests and generate a snapshot of the application depicting the state of the application resulting from the test. The documentation team may create a report for the particular version of the application code that includes the snapshots and identification of the corresponding tests.

### BRIEF SUMMARY

According to an aspect of the present disclosure, a method may include several processes. In particular, the method may include performing a series of test processes in relation to an application. In addition, the method may include recording a datastream while performing the series of test processes. The datastream may include image data representing images of the application, and each image may correspond to a state of the application. The method also may include creating entries in a database. The entries may include information identifying each process of the series of test processes and the images. Further, the method may include determining that the series of test processes performed in relation to the application have been completed. Moreover, the method may include, in response to determining that the series of test processes performed in relation to the application have been completed, querying the database for the information identifying each process of the series of test processes and the images. Further still, the method may include organizing the information identifying each process of the series of test processes and the images into a structured format. Also, the method may include generating a documentation file presenting the information identifying each process of the series of test processes and the images in the structured format.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 is a schematic representation of a network including devices providing development environments with image capture functions for application lifecycle management, including documentation and support.

FIG. 2 is a schematic representation of a system configured to provide development environments with image capture functions for application lifecycle management, including documentation and support,

FIG. 3 illustrates a documentation process for application lifecycle management,

FIG. 4 illustrates an example of images of an application and test information organized in a structured format.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RE, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism fur implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to application development, systems and methods disclosed herein may be related to software development in any field. Such development may include, but is not limited to, patches, repairs, upgrades, development of new features and/or functions, and other software changes that require modifications, additions, or deletions of software code. Systems and methods disclosed herein may be applicable to a broad range of applications that perform a broad range of processes.

During the software development process, a need may arise to track and monitor the effects of changes to an application's codebase. By tracking and monitoring the effects of changes to an application's codebase, a developer may better understand how such changes affect the operation of the application. Moreover, the developer may refer back to such information to identify the culprit code causing problems for an application and to gain a more holistic understanding of the code. This may be especially important when several developers are working on the same application or when a new developer starts working with existing code developed by another.

Systems and methods herein provide a mechanism for automatically logging tests applied to an application by a developer, recording the application's behavior in response to each test, and generating a support file that presents images of the application with information about the tests in a structured format. Accordingly, certain implementations of the present invention may automatically create support material that readily depicts an application's behavior in response to such tests and that does so in a manner that the developer may readily understand. Moreover, such tests may be run, and such support material may be developed, each time a new version of the application and/or application code is pushed out by the developer, such that the support material may include information about the history of the application throughout the application's lifecycle.

In some configurations, a developer or other party reviewing the support material may even be permitted to change, update, and/or add information related to the tests and/or images in the support material. For example, a developer may make detailed notes about what she is doing, how she modified the application, or how the application responded to the modification.

Systems and methods disclosed herein may provide an automatic way for developers to document changes to an application and the effects of such changes upon the application. Unlike existing systems and methods that require a documentation team to review an application after the developer has completed her work, the systems and methods disclosed herein may eliminate the need for the documentation team's services by creating support material on the fly as the developer tests and debugs her application.

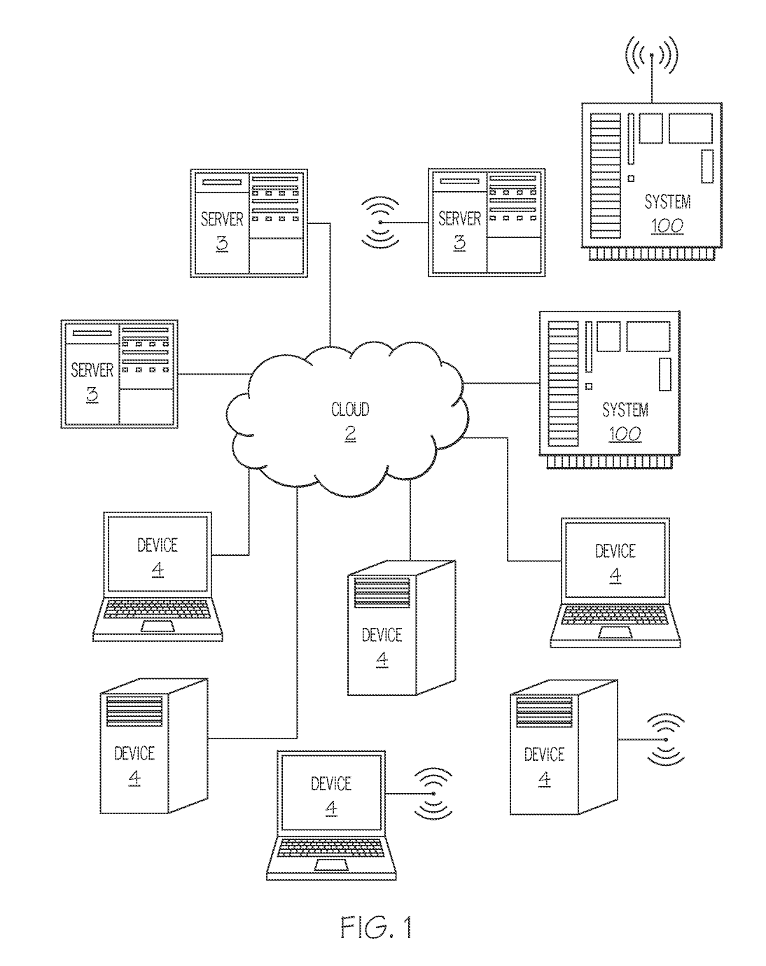

Referring now to FIG. 1, a network 1 within which a developer may build, access, modify, use, and/or test an application now is described. Network 1 may comprise one or more clouds 2, which may be public clouds, private clouds, or community clouds. Each cloud 2 may permit the exchange of information and services among users that are connected to such clouds 2. In certain configurations, cloud 2 may be a wide area network, such as the Internet. In some configurations, cloud 2 may be a local area network, such as an intranet. Further, cloud 2 may be a closed, private network in certain configurations, and cloud 2 may be an open network in other configurations. Cloud 2 may facilitate wired or wireless communications of information among users that are connected to cloud 2.

Network 1 may comprise one or more servers 3 and other devices operated by service providers and users. Network 1 also may comprise one or more devices 4 utilized by users. Service providers and users may provide information to each other utilizing the one or more servers 3, which connect to the one or more devices 4 via cloud 2. Servers 3 may comprise, for example, one or more of general purpose computing devices, specialized computing devices, mainframe devices, wired devices, wireless devices, monitoring devices, infrastructure devices, and other devices configured to provide information to service providers and users. Devices 4 may comprise, for example, one or more of general purpose computing devices, specialized computing devices, mobile devices, wired devices, wireless devices, passive devices, routers, switches, mainframe devices, monitoring devices, infrastructure devices, and other devices utilized by service providers and users. Exemplary items may include network 1, cloud 2, servers 3, and devices 4.

Moreover, network 1 may comprise one or more systems 100 that may provide a development environment that incorporates a documentation feature and/or other lifecycle management features disclosed herein. System 100 may be, for example, one or more of a general purpose computing device, a specialized computing device, a wired device, a wireless device, a mainframe device, an infrastructure device, a monitoring device, and any other device configured to provide an application with wiki features integrated therein. System 100 may also be configured to collect data from one or more data sources (e.g., servers, sensors, networks, interfaces, other devices). System 100 may receive information from and/or transmit information to network 1, cloud 2, servers 3, devices 4, and other devices connected to cloud 2. System 100 may connect to cloud 2 and monitor network 1, cloud 2, servers 3, devices 4, and other devices connected to cloud 2 for available information. The available information may be user information, access information, performance information, infrastructure information, software or application information, usability information, and other information provided by service providers and users. For example, by collecting the available information from network 1, cloud 2, servers 3, devices 4, and other devices connected to cloud 2, system 100 may perform one or more processes associated with the application under development. In some configurations, one or more of servers 3 and devices 4 may comprise system 100. In other configurations, system 100 may be separate from servers 3 and devices 4.

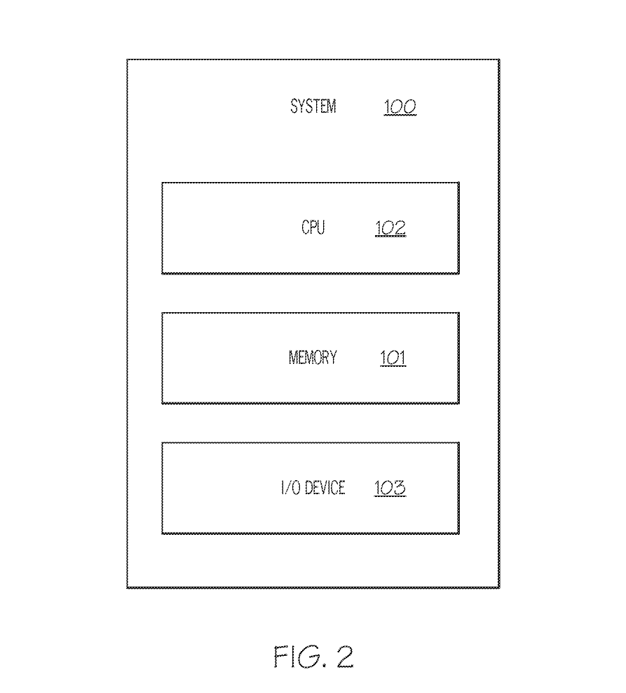

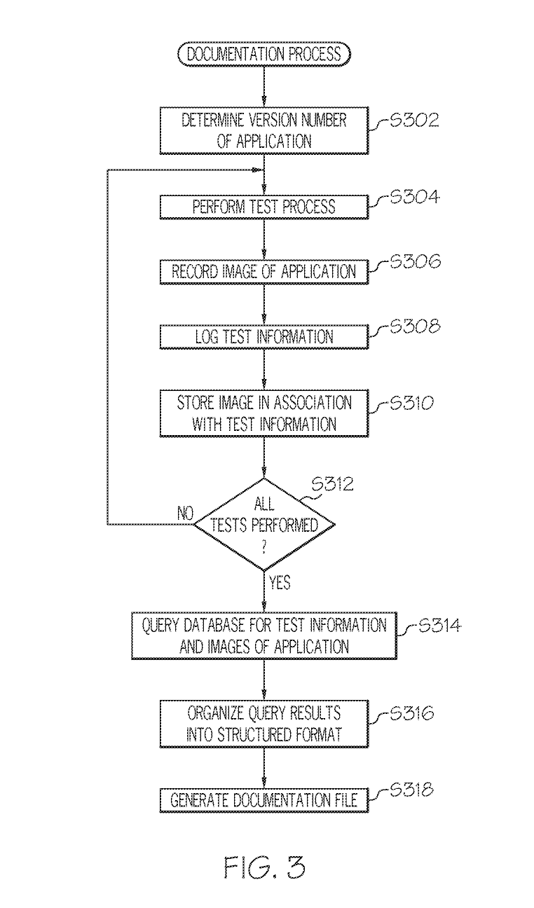

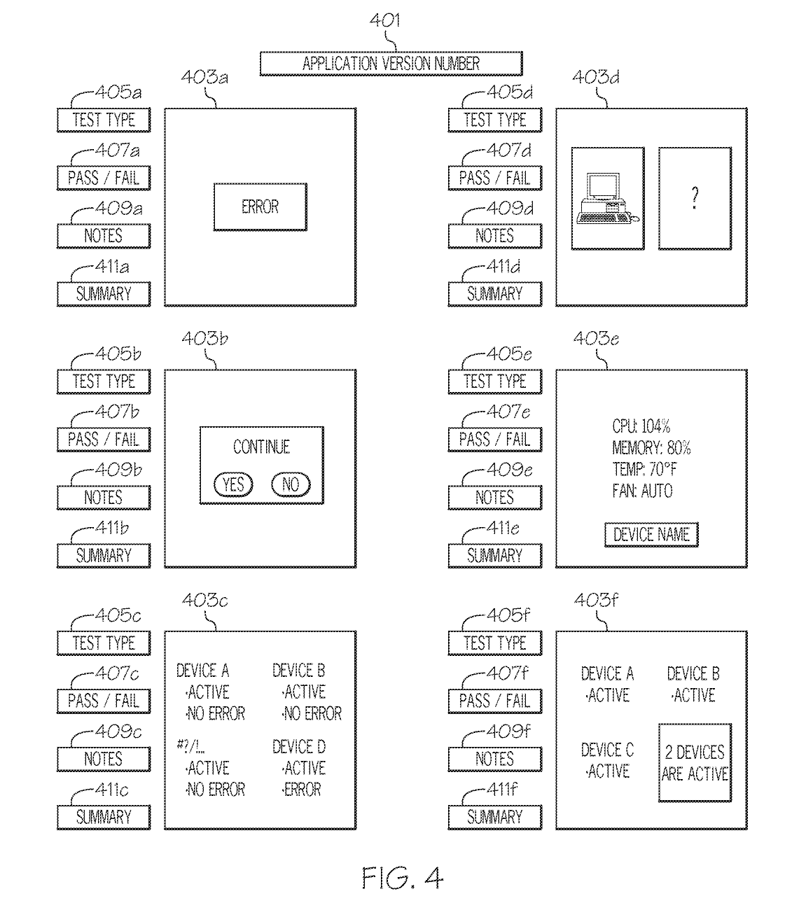

Referring to FIG. 2, system 100 is now described. System 100 may reside on one or more networks 1. System 100 may comprise a memory 101, a central processing unit (“CPU”) 102, and an input and output (“I/O”) device 103. Memory 101 may store computer-readable instructions that may instruct system 100 to perform certain processes. In particular, memory 101 may store a plurality of application programs that are under development. Memory 100 also may store a plurality of scripts that include one or more testing processes for evaluation of the applications. When computer-readable instructions, such as an application program or a script, are executed by CPU 102, the computer-readable instructions stored in memory 101 may instruct CPU 102 to perform a plurality of functions. Examples of such functions are described below with respect to FIGS. 3 and 4.

I/O device 103 may receive one or more of data from networks 1, data from other devices and sensors connected to system 100, and input from a user and provide such information to CPU 102, I/O device 103 may transmit data to networks 1, may transmit data to other devices connected to system 100, and may transmit information to a user (e.g., display the information, send an e-mail, make a sound). Further, I/O device 103 may implement one or more of wireless and wired communication between system 100 and other devices.

Referring to FIG. 3, a documentation process for application lifecycle management now is described.

In S302, system 100 may determine a version number for an application and/or for the application code. The version number may be associated with a particular version of an application that is under development. Further, the version number may he updated every time the application code is modified, every time the application is tested, after the developer provides an indication that the version is at least temporarily finalized (e.g., ready for testing, all changes have been made, a new feature or component has been added, an existing component or feature has been modified or removed, the developer has saved the software code, the developer has compiled the software code), or every time the documentation process is performed, for example.

In S304, system 100 may perform a test process on the application. For example, the test process may include running a script that performs an action within the application, such as opening a window, selecting a menu item or other command, triggering a function or other logic within the application, downloading or searching for an update for the application, closing or restarting the application, or utilizing other features within the application. In some configurations, the developer may perform the action herself without running a script by, for example, using an input device to perform or trigger such action.

In S306, system 100 may record a datastream from the application while the test is being performed on the application. For example, the datastream may be a video of the application while the test is being performed, a series of snapshots of the application while the test is being performed, and/or a data feed from the application while the test is being performed. The data stream may include one or more images (e.g., snapshots) of the application, which may depict the application's response to the test. FIG. 4, which is described below in more detail, shows images 403a-f that are examples of images from the recorded datastream. Each image may correspond to a particular state of the application.

In S308, system 100 may log information about the test being performed. Such test information may include, for example, one or more of information identifying the type of the test (e.g., what was being tested, what actions occurred during the test, the date or time that the test was performed, the duration of the test), information indicating the results of the test (e.g., whether the application passed or failed the test, performance data about the application during the test, such as CPU or memory utilization or speed of the application), and other information about the test. In configurations in which the developer manually performs the test, for example, system 100 may log the actions of the developer as the test is being performed. Logging the information about the test being performed may include, for example, storing the information in memory 101 or in another memory external to system 100, such as in a server within cloud 2 or elsewhere in network 1. In this manner, system 100 may create a database including information identifying the characteristics of each test performed.

Processes S304, S306, and S308 may be performed simultaneously, in series, or in some combination thereof, for example.

In S310, system 100 may store one or more images from the recorded datastream with the information about the test that was being performed while the one or more images were being recorded. For example, the images may be stored in a database (e,g., in memory 101, on a remote server) with the information about the test that was being performed at the time the images were recorded, such that the images are associated with the test information. Consequently, system 100 may create a database including information identifying the characteristics of each test performed and the one or more images corresponding to the state of the application when such test was performed. The information and images may be associated with the version of the application determined in S302.

In S312, system 100 may determine if all tests to be performed on the application have been performed. For example, after a version of the application has become ready for testing (e.g., substantially finalized, the developer starts a test process), system 100 may determine that a plurality of tests are to be performed on the application. Such tests may be part of a single script or a plurality of scripts, for example. For example, the plurality of tests to be performed may be a series of tests that activate each command and/or menu item within the application to determine if all such commands and/or menu items function properly, wherein each test includes activating one command and/or menu item. In another example, the plurality of tests to be performed may be a group of tests in which each test includes activating a group of commands in a different order permutation to determine whether any of the order permutations cause an error in the application. In other configurations, the plurality of tests may be a battery of tests specified by the developer.

If system 100 determines that all of the tests to be performed have not yet been performed (S312: No), the process may return to S304, and system 100 may perform another test. If system 100 determines that all of the tests to be performed have been performed (S312: Yes), the process may proceed to S314.

In S314, system 100 may query the database for the information identifying the characteristics of each test performed on the particular version of the application and for the image or images associated with each test. In this manner, system 100 may determine information about the tests, such as the number of tests performed on the version, the types of such tests, how the application performed in response to the tests, and the appearance of the application (e.g., via the images) during and/or after completion of the test, for example.

In S316, system 100 may organize query results into a structured format. In particular, system 100 may organize the test information and images associated with the particular version of the application into a format that may readily document and convey information about the performance and/or state of the particular version of the application to the developer and/or other users. FIG. 4, which is described in more detail below, is an example of such a structured format. The query results in the structured format may be associated with the particular version of the application (e.g., the version number determined in S302).

In S318, system 100 may generate and output a documentation file that includes the test information and images associated with the particular version of the application in the structured format. Developers and other individuals may thereafter access the generated file to view the test information and images associated with the particular version of the application in the structured format to quickly ascertain the performance of the application and to determine whether and/or how the application needs to be revised, updated, and/or modified. In this manner, a documentation process distinct from the development process may be avoided.

The above-described documentation process may be performed each time a new version of the application is finalized, for example. In some configurations, the documentation process may be initiated by the developer at the developer's discretion, for example.

Referring now to FIG. 5, an example of images of an application and test information organized in a structured format now is described. FIG. 5 shows various examples of images (e.g., images 403a-f) recorded (e.g., in S306) while performing a test process (e.g., in S304) organized into a structured format (e.g., a result of S316) with information identifying each test process. The elements shown in FIG. 5 may document a plurality of test processes applied to a particular version of an application, as identified by application version number 401. The elements may be structured so that a user reviewing the documentation file may easily and quickly recognize characteristics of the application (e.g., problems, defects, improvements, errors) associated with each test in the series of tests performed on the particular version of the application.

For example, elements 405a-411a may include information identifying one test process of a plurality of test processes performed on the version of the application identified by application version number 401 and element 403a may be an image recorded while such test process was performed. As an example, such test process may be the action of selecting a particular command to open a particular window in the application. The information queried from the database may include information identifying the type of test (e.g., determining whether the particular command is operable by activating the particular command), which may be displayed in a test type area 405a, for example; information identifying how the application performed during the test (e.g., whether the application passed or failed the test, such as whether the desired window appeared, whether the level of desired performance was achieved, what level of performance was achieved), which may be displayed in a pass/fail area 407a; information about the test itself and/or information input by a user reviewing the documentation file, which may be displayed in notes area 409a; and a more-detailed summary of the test, such as the date/time when the test was performed, additional performance information about the application, a description of processes performed during the test, and other information, which may be displayed in summary area 411a. Such information may be displayed in association with one or more image that was captured while the test was being performed (or after the test terminated), such as image 403a, which shows that the test resulted in an error message.

Elements 403b-411b may be substantially similar to elements 403a-411a, except that elements 403b-411b may represent a different test, such as activating a command different from the particular command described above with respect to elements 403a-411a. Here, for example, image 403b indicates that the different command did not produce an error and is likely functioning correctly.

Elements 403c-411c may be substantially similar to elements 403a-411a, except that elements 403c-411c may represent yet another different test, such as performing an action to obtain information about a plurality of devices being monitored by the application. Here, for example, image 403c indicates that the application appropriately displayed information for devices A, B, and D, but did not correctly display the name of device C, instead displaying a nonsensical character string (e.g., “#?/! . . . ”). Consequently, a developer accessing the documentation file may quickly see that there is an error in the application and readily identify the error by viewing image 403c, may quickly determine what test caused the error by viewing the information in elements 405c-411c, and may use this information to modify the application to address the error.

Similarly to above, elements 403d-411d may be substantially similar to elements 403a-411a, except that elements 403d-411d may represent still another different test, such as performing an action to display images of devices being monitored by the application. Here, fur example, image 403c indicates that the application appropriately displayed an image of one device, but did not correctly display the image of another device, instead displaying a missing image indicator (e.g., “?”). Consequently, a developer accessing the documentation file may quickly see that there is another error in the application and readily identify the error by viewing image 403d, may quickly determine what test caused the error by viewing the information in elements 405d-411d, and may use this information to modify the application to address the error.

Likewise, elements 403e-411e may be substantially similar to elements 403a-411a, except that elements 403e-411e may represent a further different test, such as performing an action to obtain information about a single device being monitored by the application. Here, for example, image 403e indicates that the application appropriately displays the deice name and information about the memory, CPU temperature, and fan settings, but indicates that the CPU utilization is at an impossible level of 104%. Consequently, a developer accessing the documentation file may quickly identify this subtle, but critical, error in the application by viewing image 403e, may quickly determine what test caused the error by viewing the information in elements 405e-411e, and may use this information to modify the application to address the error.

In yet another example, elements 403d-411d may be substantially similar to elements 403a-411a, except that elements 403d-411d may represent a further different test, such as performing an action to obtain information about a plurality of devices being monitored by the application. Here, for example, image 403e indicates that the application appropriately displays the device names and information about devices A, B, and C, but indicates incorrectly that only two devices are active when three devices appear to have active status. Consequently, a developer accessing the documentation file may quickly identify this subtle, but critical, error in the application by viewing image 403d, may quickly determine what test caused the error by viewing the information in elements 405d-411d, and may use this information to modify the application to address the error.

In some implementations, the structured format presented above may permit a user accessing the documentation file to modify one or more of entries 405a-f, 407a-f, 409a-f, and 411a-f to correct errors, remove information, and/or add information. In certain configurations, each note portion 409a-f may be a portion in which the user accessing the documentation file may add or edit notes about the particular test for later reference by the user or another user. In some configurations, the documentation file may be presented in a wiki-like format in which the documentation file is hosted by a server and made available to a plurality of users that may edit, add to, or delete from one or more of entries 405a-f, 407a-f, 409a-f, and 411a-f. In such configurations, the documentation file available to all such users may be changed accordingly such that the changes to entries 405a-f, 407a-f, 409a-f, and 411a-f may be made available to all of the users. In certain configurations, system 100 may even update the database entries created in S308 and S310 to reflect such changes and/or to incorporate such additional insight from the users.

In some configurations, the structured format may present information about two distinct versions of the application together. For example, if the same plurality of tests are performed on a first version of the application and a second version of the application, system 100 may query the database for information and images associated with both versions of the application and arrange the images and test information for both versions of the application together, so that a user reviewing the documentation file may easily see differences in how the application responded to the tests. In such configurations, system 100 may even add an additional area to the structured format that shows the changes in the application code. In this manner, a user may readily identify what changes to the application may have caused an error or improved the application.

The flowcharts and diagrams in FIGS. 1-4 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method comprising:
performing a series of test processes in relation to an application;
recording a datastream while performing the series of test processes, the datastream including image data representing a plurality of images of the application, and each image of the plurality of images corresponding to a state of the application;
creating entries in a database, the entries including information identifying each process of the series of test processes and the plurality of images;
determining that the series of test processes performed in relation to the application have been completed;
in response to determining that the series of test processes performed in relation to the application have been completed, querying the database for the information identifying each process of the series of test processes and the plurality of images;
organizing the information identifying each process of the series of test processes and the plurality of images into a structured format; and
generating a documentation file presenting the information identifying each process of the series of test processes and the plurality of images in the structured format.

2. The method of claim 1, wherein recording the datastream while performing the series of test processes comprises:
recording the information identifying each process of the series of test processes while performing the series of test processes.

3. The method of claim 1, wherein the structured format identifies changes in a state of the application between a previous version of the application and a current version of the application.

4. The method of claim 1, wherein the series of test processes are structured to evaluate the results of remedial measures to correct a defect.

5. The method of claim 1, wherein the series of test processes are structured to evaluate a new development added to the application.

6. The method of claim 1, wherein the series of test processes are structured to evaluate an enhancement to the application.

7. The method of claim 1, wherein creating the entries in the database comprises:
presenting a standard identifier for each process of the series of test processes in a manner that permits user modification of the standard identifier;
receiving an instruction to modify the standard identifier for a test process of the series of test processes; and
creating an entry for the test process in the database, the entry including the standard identifier for the test process as modified by the instruction.

8. A system comprising:
a processing system configured to:
perform a series of test processes in relation to an application;
record a datastream while performing the series of test processes, the datastream including image data representing a plurality of images of the application, and each image of the plurality of images corresponding to a state of the application;
create entries in a database, the entries including information identifying each process of the series of test processes and the plurality of images;
determine that the series of test processes performed in relation to the application have been completed;
in response to determining that the series of test processes performed in relation to the application have been completed, query the database for the information identifying each process of the series of test processes and the plurality of images;
organize the information identifying each process of the series of test processes and the plurality of images into a structured format; and
generate a documentation file presenting the information identifying each process of the series of test processes and the plurality of images in the structured format.

9. The system of claim 8, wherein, when recording the datastream while performing the series of test processes, the processing system is configured to:
record the information identifying each process of the series of test processes while performing the series of test processes.

10. The system of claim 8, wherein the structured format identifies changes in a state of the application between a previous version of the application and a current version of the application.

11. The system of claim 8, wherein the series of test processes are structured to evaluate the results of remedial measures to correct a defect.

12. The system of claim 8, wherein the series of test processes are structured to evaluate a new development added to the application.

13. The system of claim 8, wherein the series of test processes are structured to evaluate an enhancement to the application.

14. The system of claim 8, wherein, when creating the entries in the database, the processing system is configured to:
present a standard identifier for each process of the series of test processes in a manner that permits user modification of the standard identifier;
receive an instruction to modify the standard identifier for a test process of the series of test processes; and
create an entry for the test process in the database, the entry including the standard identifier for the test process as modified by the instruction.

15. A computer program product comprising:
a computer readable storage medium having computer readable program code embodied therewith, the computer readable program code comprising:
computer readable program code configured to perform a series of test processes in relation to an application;
computer readable program code configured to record a datastream while performing the series of test processes, the datastream including image data representing a plurality of images of the application, and each image of the plurality of images corresponding to a state of the application;
computer readable program code configured to create entries in a database, the entries including information identifying each process of the series of test processes and the plurality of images;
computer readable program code configured to determine that the series of test processes performed in relation to the application have been completed;
computer readable program code configured to, in response to determining that the series of test processes performed in relation to the application have been completed, query the database for the information identifying each process of the series of test processes and the plurality of images;
computer readable program code configured to organize the information identifying each process of the series of test processes and the plurality of images into a structured format; and
computer readable program code configured to generate a documentation file presenting the information identifying each process of the series of test processes and the plurality of images in the structured format.

16. The computer program product of claim 15, wherein the computer readable program code configured to record the datastream comprises:
computer readable program code configured to record the information identifying each process of the series of test processes while performing the series of test processes.

17. The computer program product of claim 15, wherein the structured format identifies changes in a state of the application between a previous version of the application and a current version of the application.

18. The computer program product of claim 15, wherein the series of test processes are structured to evaluate the results of remedial measures to correct a defect.

19. The computer program product of claim 15, wherein the series of test processes are structured to evaluate a new development added to the application.

20. The computer program product of claim 15, wherein the computer readable program code configured to create the entries in the database comprises:
computer readable program code configured to present a standard identifier for each process of the series of test processes in a manner that permits user modification of the standard identifier;
computer readable program code configured to receive an instruction to modify the standard identifier for a test process of the series of test processes; and
computer readable program code configured to create an entry fir the test process in the database, the entry including the standard identifier for the test process as modified by the instruction.
